(19) United States
(12) Patent Application Publication
(10) Pub. No.: US 2017/0288861 A1
(43) Pub. Date: Oct. 5, 2017

(54) DATA ENCRYPTION

(71) Applicant: HEWLETT PACKARD ENTERPRISE DEVELOPMENT LP, Houston, TX (US)

(72) Inventor: Oliver Matthews, Bristol (GB)

(21) Appl. No.: 15/507,561

(22) PCT Filed: Jan. 30, 2015
(86) PCT No.: PCT/US2015/013761

§ 371 Date: Feb. 28, 2017

(51) Int. Cl. H04L 9/06; H04L 9/32

(52) U.S. Cl. CPC H04L 9/0637; H04L 9/0643; H04L 9/3242; H04L 9/12

(57) ABSTRACT

In some examples, applying a first encryption process to input data blocks for encrypted data blocks, applying a deduplication process to the encrypted data blocks for chunks and first hashes, applying a deduplication process to the hashes for a first set of deduplicated hashes and sending it to destination computer. If there are missing data blocks at the computer based on the first set of deduplicated hashes: receiving a second set of deduplicated hashes of the missing data blocks, selecting chunks from the input data blocks of the missing data blocks from the second set of deduplicated hashes, applying a second encryption process to selected chunks for encrypted data chunks, and applying a third encryption process to the first hashes for first encrypted hashes.

### BACKGROUND

Computer systems may include source computers that send data to destination computers over a network. Source computers may include encryption functionality using encryption keys to change or encode source data from one form to another to hide the original meaning of the data, when it is stored on a destination computer as well as when it is sent as destination data to a destination computer over a network or other communication channel. Computer systems may also include deduplication functionality for eliminating duplicate copies of repeating data.

### BRIEF DESCRIPTION OF THE DRAWINGS

FIG. 1 is a block diagram of a computer system for data encryption according to an example implementation.

FIG. 2 is a flow diagram for performing data encryption according to an example implementation.

FIG. 3 is a block diagram of data encryption according to another example implementation.

FIG. 4 is a block diagram of data encryption according to another example implementation.

FIG. 5 is an example block diagram showing a non-transitory, computer-readable medium that stores instructions for a computer system for data encryption in accordance with an example implementation.

### DETAILED DESCRIPTION

Computer systems may include source computers that send data to destination computers over a network. In one example, computer systems may be configured to include client computers as source computers and server computers as destination computers. Source computers may include encryption functionality using encryption keys to change or encode source data from one form to another to hide the original meaning of the data when it is stored on a destination computer as well as when it is sent as destination data to a destination computer over a network or other communication channel. The destination computers may include decryption functionality to decode the encrypted data to be able to reveal the original meaning of the data source data. Computer systems may also include deduplication functionality for eliminating duplicate copies of repeating data.

Computer systems may attempt to apply deduplication functions to encrypted data. A computer system may employ a system using two different encryption keys and modes of operation for a data stream being sent to a deduplication module or engine. In this case, the computer system may generate encrypted data streams that may be deduplicated with approaching the level of efficiency of unencrypted data. This deduplicated data is sent as data streams without presenting the unencrypted data to the deduplication module or revealing the contents of one data stream to an owner of another data stream. Computer systems may allow multiple owners or users to generate data streams. By using varying keys for data, the systems may be able to group the data streams into entirely separated collections, at the expense of being unable to perform de-duplication between collections.

A computer system may include a deduplication module with functionality to receive input data streams comprising data blocks and to divide the data blocks into chunks or groups of data. The deduplication module may compare the chunks of data to identify duplicates to save on storage capacity. The computer system may include an encryption module with functionality to transform data to make the data illegible to a system without the correct key. As a result, encryption techniques applied to data may prevent comparisons for deduplication purposes, so while encrypting deduplicated data is possible, it may be difficult to deduplicate encrypted data.

Computer systems ay find this to be desirable for various reasons. For example, if the system has several data streams then it may encrypt the data separately but likely to be readily deduplicatable such as for desktop (Personal Computer) PC backups and the like. In another example, computer systems may not find it desirable for the data streams to be transmitted or sent from one system to another system in an unencrypted manner. In another example, computer systems may not find it desirable for other systems with access to the deduplicated data to have knowledge of the content in other data streams. In yet another example, computer systems may be generate data streams and encrypt the data before sending or handing it to another system such as a backup system as part of a backup service provider.

In one example, the techniques presented here may help improve data processing performance. For example, the techniques of the present application disclose source computers that can send data streams to destinations computers. In one example, computer systems may be configured to include client computers as source computers and server computers as destination computers. The source computers may be divided into separate groups and, within a group, data may be deduplicated and between groups the data may be isolated. Each group may be configured to have its own defined encryption key that each source computer within that group knows. Each source computer may be configured to own an encryption key that only it knows.

In one example, in operation, source computers may initiate execution of new sessions which may include scanning the data streams of source data and encrypting the streams using their collection key using Electronic Code Book (ECB) mode. ECB is a mode of operation employing a block cipher such that each block of plaintext may have a defined corresponding ciphertext value and each ciphertext may have a defined corresponding plaintext. The encrypted data may then be passed through deduplication processing to generate a series of chunks and a corresponding list of chunk hashes. From the list of hashes, the source computers may generate a deduplicated set of hashes in the stream The source computers may then send this to the destination computer which compares it to a list of hashes of blocks already stored at the destination computer. If destination computer determines that it lacks or missing any of the blocks, it returns the list of those missing blocks to the source computer. The source computer may then apply an encryption process to re-encrypt those chunks using a non-ECB mode of operation and then send that list to the destination computer. The source computer may then apply an encryption process to encrypt the original ordered list of hashes using the unique key of the source computer and a non-ECB mode of operation such as cipher-block chaining, counter techniques and the like. The source computer may then send this list to the destination computer which is stored as the list for a backup job.

In another example of the present application, disclosed is a computer comprising a data encryption and deduplication module configured to apply a first encryption process to input data blocks to generate encrypted data blocks, apply a deduplication process to the encrypted data blocks to generate chunks and first hashes, apply a deduplication process to the hashes to generate a first set of deduplicated hashes, and send the first set of deduplicated hashes to a destination computer. If the destination computer determines there are missing data blocks at the destination computer based on the first set of deduplicated hashes, then the source computer may receive from the destination computer a second set of deduplicated hashes associated with the missing data blocks, select chunks from the input data blocks corresponding to the missing data blocks from the second set of deduplicated hashes, apply a second encryption process to the selected chunks to generate a set of encrypted data chunks to be sent to the destination computer, and apply a third encryption process to the first hashes to generate a first encrypted hashes to be sent to the destination computer.

In some example of the techniques of the present application, the first encryption process may include an ECB mode of operation encryption process and employing a shared key. The second encryption process may include a non-ECB mode of operation encryption process and employing a shared key. The third encryption process may include a non-ECB mode of operation encryption process and a unique key. The second set of encrypted hashes may be stored at the destination computer as part of a backup process. The deduplication process may divide input data or data streams into chunks or block of data with fixed or variable size or block boundaries. The deduplication process compares chunks of data to detect duplicates. The deduplication process assigns an identification to each chunk of data such as hashes through cryptographic hash functions.

In this manner, the techniques presented here may improve data processing performance. For example, the techniques may allow the source computer to prevent the destination computer from having knowledge of the unencrypted data. The source computer may be configured to not share or show any of the encryption keys to a destination computer. The source computer may only share or show destination computer data that is encrypted using a secure mode of encryption. Even if an intruder or other unauthorized user gains access to a destination computer through unauthorized means, it is not possible for the intruder to determine which chunks correspond to which source computer without the key of the source computer. Further, even if an intruder has a collection key, it may be able to guess which chunks belong to that collection, but the intruder may not able to map it to individual source computers. If only a single collection key is used (which may provide improved or optimal deduplication performance), then the deduplication rate may approach that of systems deduplicating unencrypted streams. The data streams may deduplicate as well as unencrypted streams such that the difference is that the hash lists may no longer be deduplicated. However, the hash lists may be several orders of magnitude smaller than the data streams (where the typical chunk size is about 4 kbytes, hash 64 bytes). The encryption process is performed at the source computer which may allow destination computer performance to be similar to an unencrypted deduplicated solution.

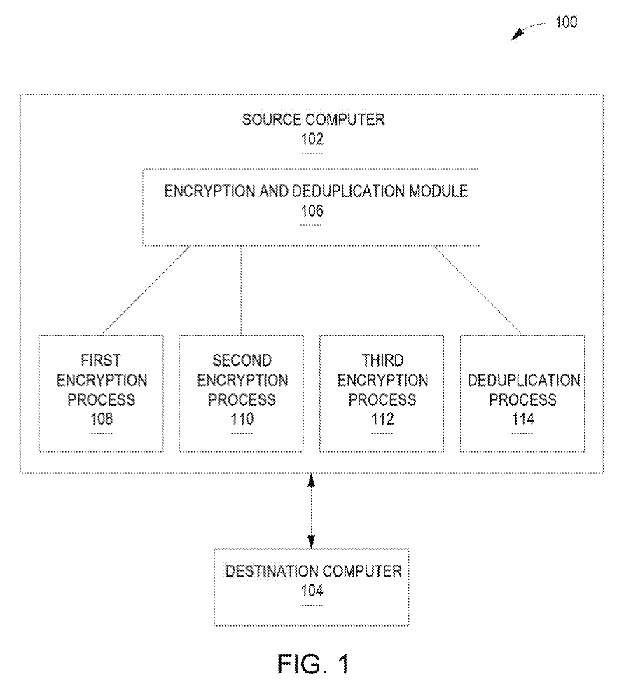

FIG. 1 is a block diagram of a computer system 100 for data encryption in accordance with an example implementation.

In one example, computer system 100 includes a source computer 102 coupled to a destination computer 104. The source computer 102 includes an encryption and deduplication module 106 for processing input data blocks from an input data stream of a host and sending the processed data to destination computer 104.

The encryption and deduplication module 106 includes a plurality of encryption processes for encrypting data including a first encryption process 108, a second encryption process 110 and third encryption process 112. The encryption and deduplication module 106 includes deduplication process 114 for deduplicating data. In some examples, first encryption process 108 may include an ECB mode of operation encryption process and employing a shared key. The second encryption process 110 may include a non-ECB mode of operation encryption process and employing a shared key. The third encryption process 112 may include a non-ECB mode of operation encryption process and a unique key. The second set of encrypted hashes may be stored at destination computer 104 as part of a backup process.

The data encryption and deduplication module 106 is configured to apply first encryption process 108 to input data blocks to generate encrypted data blocks. The module 106 may apply deduplication process 114 to the encrypted data blocks to generate chunks and first hashes. The module 106 may apply deduplication process 114 to the hashes to generate a first set of deduplicated hashes, and send the first set of deduplicated hashes to destination computer 104.

The destination computer 104 is configured to determine whether there are missing data blocks at the destination computer based on the first set of deduplicated hashes. If there are missing data blocks, then source computer 102 may receive from destination computer 104 a second set of deduplicated hashes associated with the missing data blocks. The module 106 may select chunks from the input data blocks corresponding to the missing data blocks from the second set of deduplicated hashes. The module 106 may apply second encryption process 110 to the selected chunks to generate a set of encrypted data chunks to be sent to destination computer 104 The module 106 may apply a third encryption process 112 to the first hashes to generate a first encrypted hashes to be sent to destination computer 104.

The source computer 102 and destination computer 104 of system 100 may be any electronic device capable of data processing such as a client computer server computer, mobile device, notebook computer and the like. The functionality of the components of computers may be implemented in hardware, software or a combination thereof. In one example, the computers may include functionality to manage the operation of the computer device. For example, the computers may include functionality to communicate with other computer devices such as host computers to receive access commands from the host computer to access storage from a storage device.

The system 100 may include a storage device providing any means for storing data for later retrieval, In one example, the storage device may be storage disks configured to present logical storage devices to computers or other electronic devices such as hosts. The storage devices may include a plurality of storage devices configured to practice the techniques of the present application. In one example, computers of system 100 may be coupled to other computer devices such as hosts which may access the logical configuration of storage array as LUNS. The storage devices may include non-volatile memory, volatile memory or a combination thereof. Examples of non-volatile memory include, but are not limited to. Electrically Erasable Programmable Read Only Memory (EEPROM) and Read Only Memory (ROM). Examples of volatile memory include, but are not limited to, Static Random Access Memory (SRAM), and Dynamic Random Access Memory (DRAM). Examples of storage devices may include, but are not limited to, Hard Disk Drives (HDDs), Compact Disks (CDs), Solid State Drives (SSDs), optical drives, flash memory devices and other like devices.

The computers of system 100 may include any communication means for communication in system. The communication means may include any electronic communication means of communication including wired, wireless, network based such SAN, Ethernet, FC (Fibre Channel) and the like.

It should be understood that the description of system 100 above is for illustrative purposes and other implementations of the system may be employed to practice the techniques of the present application. For example, source computer 102 is shown as a single component but the management computer may be a plurality of computer systems to practice the techniques of the present application. In another example, computer systems may be configured to include client computers as source computers 102 and server computers as destination computers 104.

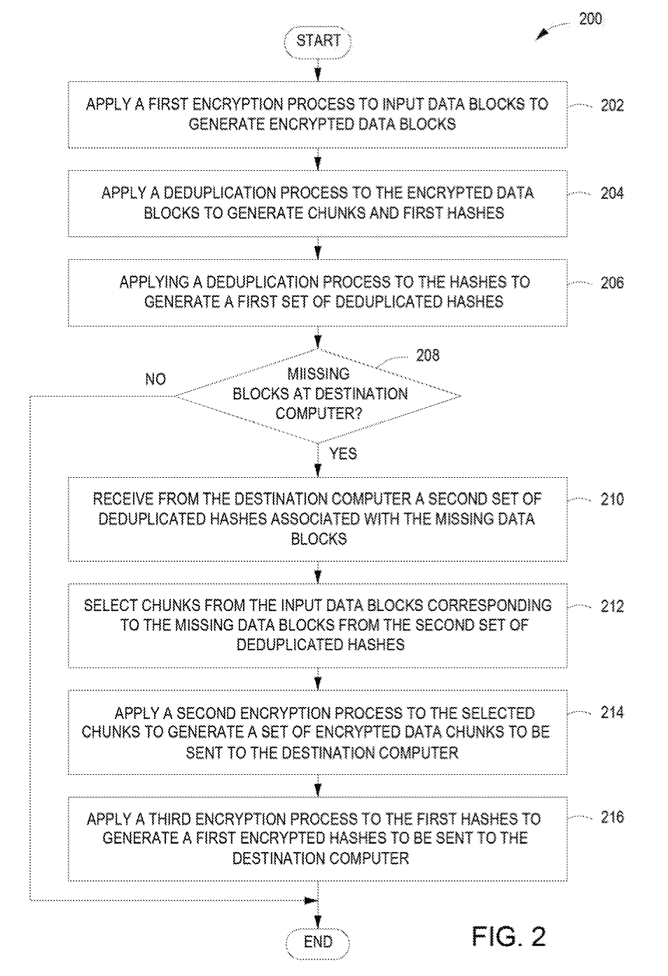

FIG. 2 is a flow diagram of a performing data encryption according to an example implementation.

In one example, to illustrate operation, it may be assumed that source computer device 102 is configured to communicate with destination computer 104 as shown in FIG. 1. It may be assumed that source computer 102 receives input data blocks as input streams from a source such as a client or user.

Processing may begin at block 202, where encryption and deduplication module 106 applies first encryption process 108 to input data blocks to generate encrypted data blocks. Processing proceeds to block 204.

At block 204, encryption and deduplication module 186 applies deduplication process 114 to the encrypted data blocks to generate chunks and first hashes. Processing proceeds to block 206.

At block 206, encryption and deduplication module 106 applies deduplication process 114 to the hashes to generate a first set of deduplicated hashes. Processing proceeds to block 208.

At block 208, encryption and deduplication module 106 checks whether there are missing blocks at destination computer 104. In one example, destination computer 104 checks or determines whether there are missing data blocks at the destination computer based on the first set of deduplicated hashes. If there are missing blocks, then processing proceeds to block 210 for subsequent processing. On the other hand, if there are no missing blocks, then processing proceeds to terminate at the end block.

At block 210, encryption and deduplication module 106 receives from destination computer 104 a second set of deduplicated hashes associated with the missing data blocks. Processing proceeds to block 212,

At block 212, encryption and deduplication module 106 selects chunks from the input data blocks corresponding to the missing data blocks from the second set of deduplicated hashes. Processing proceeds to block 214.

At block 214, encryption and deduplication module 106 applies second encryption process 110 to the selected chunks to generate a set of encrypted data chunks to be sent destination computer 104. Processing proceeds to block 216.

At block 216, encryption and deduplication module 106 applies third encryption process 112 to the first hashes to generate a first encrypted hashes to be sent to destination computer 104. Processing proceeds to terminate at the end block.

It should be understood that the above process 200 is for illustrative purposes and that other implementations may be employed to practice the techniques of the present application. For example, source computer 102 may be connected to a different number of destination computers 104.

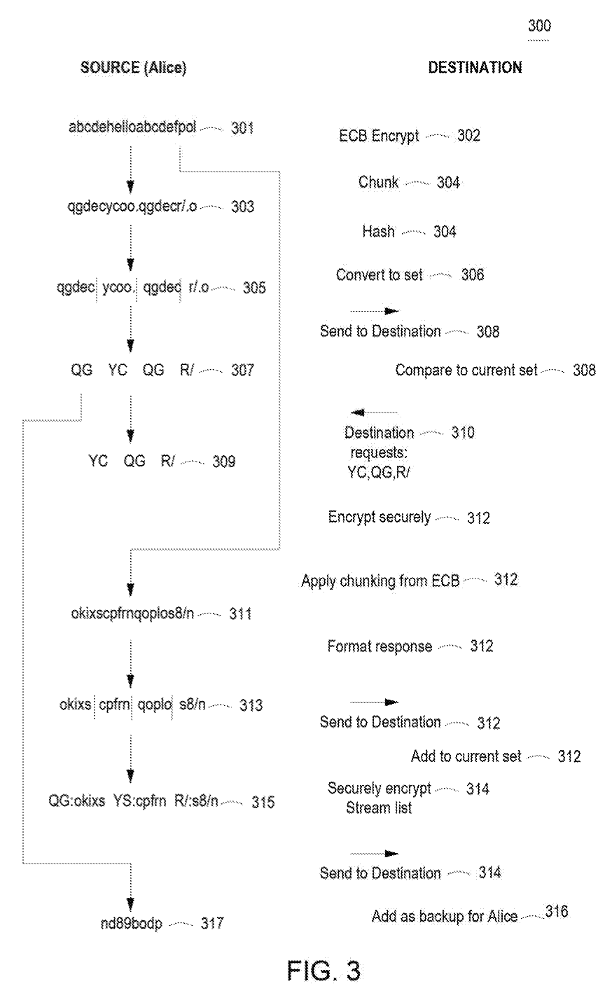

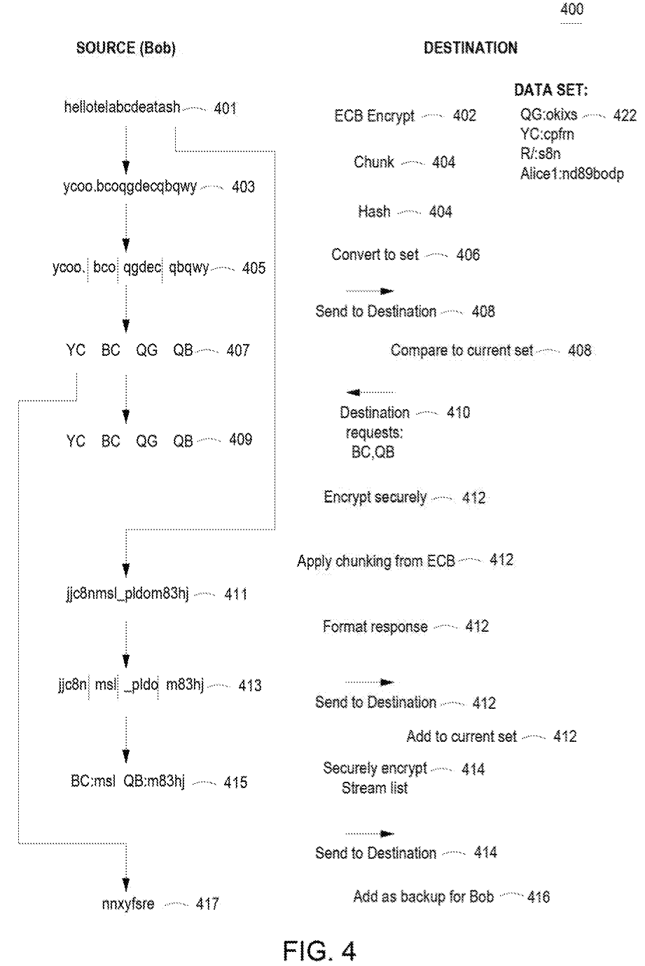

FIG. 3 is a block diagram 3013 of data encryption according to another example implementation may be, assumed that source computer 102 is configured to process input data streams and send the processed data to destination computer 104 of FIG. 1. It may be assumed that the input data stream is associated with a first user or client called “Alice”. Further, it may be assumed that this input stream is the first instance of data being processed to be send to destination computer 104. It may be further assumed that destination computer 104 has not received any of the data from source computer 104 and that the destination computer has an empty data set. Once the system processes the input data of first client, system processes a second stream of data assigned to a second user or client called “Bob”, as described in FIG. 4.

Processing may begin at block 302, where source computer 102 applies an encryption process. In one example, encryption and deduplication module 106 applies first encryption process 108 to input data blocks 301 to generate encrypted data blocks 303. In one example, module 106 applies first encryption process 108 using shared keys. Processing proceeds to block 304.

At block 304, source computer 102 applies a deduplication process to generate chunks. In one example, encryption and deduplication module 106 applies deduplication process 114 to encrypted data blocks 303 to generate chunks 305 and hashes 307. Processing proceeds to block 306.

At block 306, source computer 102 converts hashes 307 to a form 309 to be sent to destination computer 104. in one example, encryption and deduplication module 106 applies deduplication process 114 to hashes 307 to generate a first set of deduplicated hashes 309. Processing proceeds to block 308.

At block 308, source computer 102 sends first set of deduplicated hashes 309 to destination computer 104 and determines whether there are missing blocks at destination computer 104. In one example, destination computer 104 checks or determines whether there are missing data blocks at the destination computer based on first set of deduplicated hashes 309. If there are missing blocks, then processing proceeds to block 310 for subsequent processing. On the other hand, if there are no missing blocks, then processing proceeds to block 314 to store the backup list.

At block 310, destination computer 104 sends to source computer 102 requests indicating missing data blocks. In one example, encryption and deduplication module 106 receives from destination computer 104 a second set of deduplicated hashes associated with the missing data blocks. Processing proceeds to block 312.

At block 312, encryption and deduplication module 106 selects chunks from the input data blocks corresponding to the missing data blocks from the second set of deduplicated hashes. In one example, module may generate securely encrypted data 311 from data 301 and then apply deduplication process to data 311 to generate chunks 313. The module 106 may then format chunks 313 in a form 315 to be sent to destination computer 104. The destination computer 104 then adds the data 315 to a current set of data at the destination computer. In one example, module 106 may be configured in a unique proper encryption mode and employ a shared key. Further, depending on the mode chosen, module 106 may be configured to determine that only the requested chunks may be securely encrypted. In another example, “okixs” and “qoplo” are both valid encryptions of “qgdec”, just with different initialization vectors resulting from being in different parts of the incoming stream. In another example, module 106 may be configured to send the new hashes to destination computer 104 for verification of transmission purposes (e.g., QG:OK:okixs). Processing proceeds to block 314.

At block 314. source computer 102 applies second encryption process 110. In one example, encryption and deduplication module 106 applies second encryption process 110 to the selected chunks to generate a set of encrypted data chunks to be sent to destination computer 104. The destination computer 104 receives encrypted data chunks to be stored at the destination computer as part of a current set of data.

In another example, at block 314, source computer 102 applies third encryption process 112. In one example, encryption and deduplication module 106 applies third encryption process 112 to the first hashes to generate a first encrypted hashes 317 to be sent to destination computer 104. In one example, module 106 may be configured to use proper encryption mode and client-specific keys. The destination computer 104 receives hashes 317 to be stored at the destination computer as part of backup process at block 316 associated with first source “Alice”. Processing proceeds to terminate.

It should be understood that the above process 300 is for illustrative purposes and that other implementations may be employed to practice the techniques of the present application. For example, source computer 102 may process a different data stream, multiple data streams and so on to be sent to different number of destination computers 104. In one example, with respect to the format, if a data stream is encrypted as a single stream (as part of the second encryption process), then the chunk may include the following: Initial hash (e.g. QG), encrypted chunk, output block or initialization vector (depending on place in the stream) used for the start of the chunk, (optionally) actual hash of the encrypted chunk.

FIG. 4 is a block diagram 400 of data encryption according to another example implementation. It may be assumed that source computer 102 is configured to process input data streams and send the processed data to destination computer 104 of FIG. 1.

As explained above in the context of FIG. 3, it may be assumed that the input data stream is associated with a first user or client called “Alice” as stored in destination computer 104 as indicated at block 422. Now, in the context of FIG. 4. once the system processes the input data of first client, system processes a second stream of data assigned to a second user or client called “Bob”, as described in the context of FIG. 4.

Processing may be begin at block 402, where source computer 102 applies an encryption process. In one example, encryption and deduplication module 106 applies first encryption process 108 to input data blocks 401 to generate encrypted data blocks 403. In one example, module 106 applies first encryption process 108 using shared keys. Processing proceeds to block 404.

At block 404, source computer 102 applies a deduplication process to generate chunks. In one example, encryption and deduplication module 106 applies deduplication process 114 to encrypted data blocks 403 to generate chunks 405 and hashes 407. Processing proceeds to block 406.

At block 406, source computer 102 converts hashes 407 to a form 409 to be sent to destination computer 104. In one example, encryption and deduplication module 106 applies deduplication process 114 to hashes 407 to generate a first set of deduplicated hashes 409. Processing proceeds to block 408.

At block 408, source computer 102 sends first set of deduplicated hashes 409 to destination computer 104 and determines whether there are missing blocks at destination computer 104. In one example, destination computer 104 checks or determines whether there are missing data blocks at the destination computer based on first set of deduplicated hashes 409. If there are missing blocks, then processing proceeds to block 410 for subsequent processing. On the other hand, if there are no missing blocks, then processing proceeds to block 414.

At block 410, destination computer 104 sends to source computer 102 requests indicating missing data blocks. In one example, encryption and deduplication module 106 receives from destination computer 104 a second set of deduplicated hashes associated with the missing data blocks. Processing proceeds to block 412.

At block 412, encryption and deduplication module 106 selects chunks from the input data blocks corresponding to the missing data blocks from the second set of deduplicated hashes. In one example, module may generate securely encrypted data 411 and then apply deduplication process to the data 411 to generate chunks 413. The module 106 then formats chunks 413 in a form 415 to be sent to destination computer 104. The destination computer 104 then adds the data 415 to a current set of data at the destination computer. In one example, module may unique proper encryption mode and shared key. Further, depending on the mode chosen, module 106 may determine only the requested chunks may be securely encrypted. In another example, module 106 may be configured to send the new hashes for verification of transmission purposes. Processing proceeds to block 414.

At block 414, source computer 102 applies second encryption process 110. In one example, encryption and deduplication module 106 applies second encryption process 110 to the selected chunks to generate a set of encrypted data chunks to be sent to destination computer 104. The destination computer 104 receives encrypted data chunks to be stored at the destination computer as part of a current set of data.

In another example, at block 414, source computer 102 applies third encryption process 112. In one example, encryption and deduplication module 106 applies third encryption process 112 to the first hashes to generate a first encrypted hashes 417 to be sent to destination computer 104. In one example, module 106 may be configured to use proper encryption mode and client-specific keys. Thee destination computer 104 receives hashes 417 to be stored at the destination computer as part of backup process at block 416 associated with second source “Bob”. Processing proceeds to terminate.

It should be understood that the above process 400 is for illustrative purposes and that other implementations may be employed to practice the techniques of the present application. For example, source computer 102 may process a different data stream, multiple data streams and so on to be sent to different number of destination computers 104.

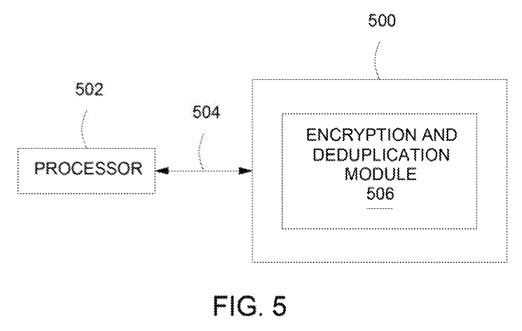

FIG. 5 is an example block diagram showing a non-transitory, computer-readable medium that stores instructions for a computer system for backup operations in accordance with an example implementation. The non-transitory, computer-readable medium is generally referred to by the reference number 500 and may be included in components of system 100 as described herein. The non-transitory, computer-readable medium 500 may correspond to any typical storage device that stores computer-implemented instructions, such as programming code or the like. For example, the non-transitory, computer-readable medium 500 may include one or more of a non-volatile memory, a volatile memory, and/or one or more storage devices. Examples of non-volatile memory include, but are not limited to, EEPROM and ROM. Examples of volatile memory include, but are not limited to, SRAM, and DRAM. Examples of storage devices include, but are not limited to, hard disk drives, compact disc drives, digital versatile disc drives, optical drives, and flash memory devices.

A processor 502 generally retrieves and executes the instructions stored in the non-transitory, computer-readable medium 500 to operate the components of system 100 in accordance with an example, In an example, the tangible, machine-readable medium 500 may be accessed by the processor 502 over a bus 504. A first region 506 of the non-transitory, computer-readable medium 500 may include encryption and deduplication module 106 functionality as described herein.

Although shown as contiguous blocks, the software components may be stored in any order or configuration. For example, if the non-transitory, computer-readable medium 500 is a hard drive, the software components may be stored in non-contiguous, or even overlapping, sectors.

What is claimed is:

1. A method comprising:
applying a first encryption process to input data blocks to generate encrypted data blocks;
applying a deduplication process to the encrypted data blocks to generate chunks and first hashes;
applying a deduplication process to the hashes to generate a first set of deduplicated hashes;
sending the first set of deduplicated hashes to a destination computer; and
if the destination computer determines there are missing data blocks at the destination computer based on the first set of deduplicated hashes:
receiving from the destination computer a second set of deduplicated hashes associated with the missing data blocks,
selecting chunks from the input data blocks corresponding to the missing data blocks from the second set of deduplicated hashes,
applying a second encryption process to the selected chunks to generate a set of encrypted data chunks to be sent to the destination computer, and
applying a third encryption process to the first hashes to generate a first encrypted hashes to be sent to the destination computer.

2. The method of claim 1, wherein the first encryption process includes an Electronic Code Book (ECB) mode of operation encryption process and a shared key.

3. The method of claim 1, wherein the second encryption process includes a non-ECB mode of operation encryption process and a shared key.

4. The method of claim 1, wherein the third encryption process includes a non-ECB mode of operation encryption process and a unique key.

5. The method of claim 1, wherein the second set of encrypted hashes is to be stored at the destination computer as part of a backup process.

6. A computer comprising:
A data encryption and deduplication module to:
apply a first encryption process to input data blocks to generate encrypted data blocks;
apply a deduplication process to the encrypted data blocks to generate chunks and first hashes;
apply a deduplication process to the hashes to generate a first set of deduplicated hashes;
send the first set of deduplicated hashes to a destination computer; and
if the destination computer determines there are missing data blocks at the destination computer based on the first set of deduplicated hashes:
receive from the destination computer a second set of deduplicated hashes associated with the missing data blocks,
select chunks from the input data blocks corresponding to the missing data blocks from the second set of deduplicated hashes,
apply a second encryption process to the selected chunks to generate a set of encrypted data chunks to be sent to the destination computer, and
apply a third encryption process to the first hashes to generate a first encrypted hashes to be sent to the destination computer.

7. The computer of claim 6, wherein the first encryption process includes an ECB (electronic code book) mode of operation encryption process and a shared key.

8. The computer of claim 6, wherein the second encryption process includes a non-ECB mode of operation encryption process and a shared key.

9. The computer of claim 6, wherein the third encryption process includes a non-ECB mode of operation encryption process and a unique key.

10. The computer of claim 6, wherein the second set of encrypted hashes is to be stored at the destination computer as part of a backup process.

11. An article comprising a non-transitory computer readable storage medium to store instructions that when executed by a computer to cause the computer to:
apply a first encryption process to input data blocks to generate encrypted data blocks;
apply a deduplication process to the encrypted data blocks to generate chunks and first hashes;
apply a deduplication process to the hashes to generate a first set of deduplicated hashes;
send the first set of deduplicated hashes to a destination computer; and
if the destination computer determines there are missing data blocks at the destination computer based on the first set of deduplicated hashes:
receive from the destination computer a second set of deduplicated hashes associated with the missing data blocks,
select chunks from the input data blocks corresponding to the missing data blocks from the second set of deduplicated hashes,
apply a second encryption process to selected chunks to generate a set of encrypted data chunks to be sent to the destination computer, and
apply a third encryption process to the first hashes to generate a first encrypted hashes to be sent to the destination computer.

12. The article of claim 11, wherein the first encryption process includes an ECB (electronic code book) mode of operation encryption process.

13. The article of claim 11, wherein the second encryption process includes a non-ECB mode of operation encryption process and a shared key.

14. The article of claim 11, wherein the third encryption process includes a non-ECB mode of operation encryption process and a unique key.

15. The article of claim 11, wherein the second set of encrypted hashes is to be stored at the destination computer as part of a backup process and a shared key.
